(19) United States
(12) Patent Application Publication
(10) Pub. No.: US 2023/0236627 A1
(43) Pub. Date: Jul. 27, 2023

(54) DISPLAY PANEL

(71) Applicant: KunShan Go-Visionox Opto-Electronics Co., Ltd, Kunshan, Jiangsu (CN)

(72) Inventor: Wei ZHANG, Kunshan (CN)

(73) Assignee: KunShan Go-Visionox Opto-Electronics Co., Ltd, Kunshan, Jiangsu (CN)

(21) Appl. No.: 18/192,919

(22) Filed: Mar. 30, 2023

Related U.S. Application Data
(63) Continuation of application No. PCT/CN2021/129139, filed on Nov. 5, 2021.

(30) Foreign Application Priority Data
Jan. 29, 2021 (CN) 202110129051.4

(51) Int. Cl. G06F 1/16; H04M 1/02

(52) U.S. Cl. CPC G06F 1/1616; G06F 1/1656; G06F 1/1652; H04M 1/0214; H04M 1/0268

(57) ABSTRACT

A display panel, a display apparatus, and a fabrication method of a display panel. The display panel includes a display region and a non-display region, the non-display region includes a bonding region and an unbonding region, and the display panel includes: a display substrate including a substrate and a display device layer disposed on the substrate. The display device layer is at least partially located in the display region; a polarizer disposed on a side of the display device layer away from the substrate, The polarizer includes a first surface away from the substrate, a second surface close to the substrate, and a side surface connecting the first surface and the second surface; a protection layer including a side protection portion covering at least the side surface.

### CROSS-REFERENCE TO RELATED APPLICATION

The present application is a continuation of International Application No. PCT/CN2021/129139, filed on Nov. 5, 2021 and entitled “DISPLAY PANEL”, which claims priority to Chinese Patent Application No. 202110129051.4, filed on Jan. 29, 2021 and entitled “DISPLAY PANEL, DISPLAY APPARATUS, AND FABRICATION METHOD OF DISPLAY PANEL”, both of which are hereby incorporated by reference in their entireties.

### TECHNICAL FIELD

The present application relates to a technical field of display apparatuses, and in particular to a display panel.

### BACKGROUND

With the continuous update of display module technology, small-sized panels are gradually developing towards thinner and lighter panels, high screen-to-body ratios, ultra-narrow frames, and even frame-less. A display panel with a traditional structure usually includes a display region and a bending region located on the circumferential side of the display region. The layer structure in the bending region needs to be bent. After the layer structure is bent, cracks and gaps may occur, especially at the circumferential side of the polarizer. Therefore, water and oxygen can invade the polarizer, and the external water and oxygen will interact with the polarizer, thereby affecting the yield of the polarizer.

### SUMMARY

The embodiments of the present application provides a display panel.

An embodiment in a first aspect of the present application provides a display panel, wherein the display panel includes a display region and a non-display region, the non-display region includes a bonding region and an unbonding region, and the display panel includes: a display substrate including a substrate and a display device layer disposed on the substrate, wherein the display device layer is at least partially located in the display region; a polarizer disposed on a side of the display device layer away from the substrate, wherein the polarizer includes a first surface away from the substrate, a second surface close to the substrate, and a side surface connecting the first surface and the second surface; a protection layer including a side protection portion covering at least the side surface.

An embodiment of the present application provides a fabrication method of a display panel, wherein the display panel includes a display region and a non-display region, the non-display region includes a bonding region and an unbonding region, wherein the fabrication method includes:
providing a display substrate, wherein the display substrate includes a substrate as well as a display device layer and a metal wiring layer disposed on the substrate and interconnected with each other, wherein the display device layer is located in the display region, and the metal wiring layer is located in the bonding region;
disposing a third protection layer on a side of the display device layer away from the substrate;
disposing a polarizer on a side of the third protection layer away from the display device layer, wherein the polarizer includes a first surface, a second surface opposite to the first surface, and a side surface connecting the first surface and the second surface;
disposing a first optical glue layer on a side of the polarizer away from the display substrate, wherein the first optical glue layer includes a first protection layer;
performing a cutting process in the unbonding region, so that a first protection portion, a second protection portion and a first sub-portion are formed by the first protection layer and the third protection layer, wherein the first protection portion is located on a side of the polarizer away from the display device layer, the first sub-portion contacts a part of the side surface, and the second protection portion is located on a side of the polarizer toward the display device layer.

According to any one of the above implementations of the present application, after performing the cutting process in the unbonding region, the fabrication method further includes:
removing the first duplex film layer;
disposing a cover plate on the side of the first protection layer away from the polarizer;
performing a defoaming and curing process to form the display panel.

### BRIEF DESCRIPTION OF THE DRAWINGS

Other features, purposes and advantages of the present application will become more apparent by reading the following detailed description of non-limiting embodiments with reference to the accompanying drawings. Here, like or similar reference numerals indicate like or similar features.

FIG. 1 is a schematic structural diagram of a display panel provided by an embodiment of the present application;

FIG. 2 is a schematic structural diagram of a display panel provided by another embodiment of the present application;

FIG. 3 is a cross-sectional view of an example of the display panel shown in FIG. 1 along A-A;

FIG. 4 is a cross-sectional view of another example of the display panel shown in FIG. 1 along A-A;

FIG. 5 is a schematic flowchart of a fabrication method of a display panel provided by an embodiment of the present application.

### DETAILED DESCRIPTION

The features and exemplary embodiments of various aspects of the present application will be described in detail below. In the following detailed description, numerous specific details are set forth in order to provide a thorough understanding of the present application. However, it will be apparent to those skilled in the art that the present application may be practiced without some of these specific details. The following description of the embodiments is merely intended to provide a better understanding of the present application by illustrating examples of the present application. In the drawings and the following description, at least some well-known structures and techniques are not shown in order to avoid unnecessarily obscuring of the present application; and for clarity, the dimensions of some structures may be exaggerated. Furthermore, the features, structures, or characteristics described hereinafter may be combined in any suitable manner in one or more embodiments.

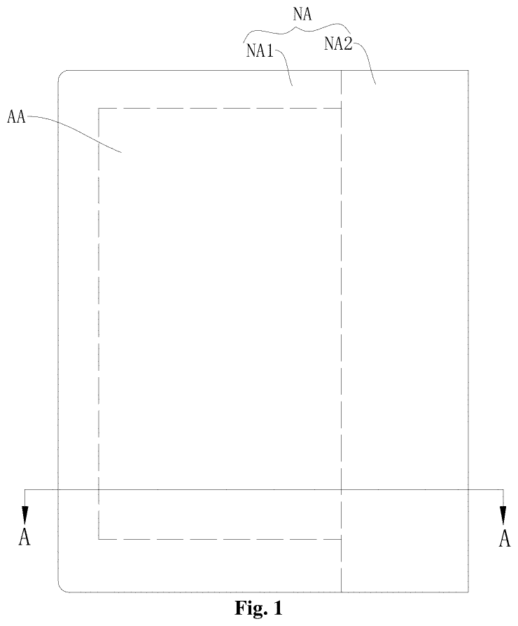

In order to better understand the present application, a display panel, a display apparatus, and a fabrication method of a display panel according to the embodiments of the present application will be described in detail below with reference to FIGS. 1 to 4.

Please refer to FIG. 1. FIG. 1 is a schematic structural diagram of a display panel provided by an embodiment of a first aspect of the present application. The display panel includes a display region AA and a non-display region NA, and the non-display region NA includes a bonding region NA2 located on at least one side of the display region AA. The non-display region NA further includes an unbonding region NA1. According to the display panel provided by the embodiments of the present application, the bonding region NA2 may be located on the same plane as the display region AA.

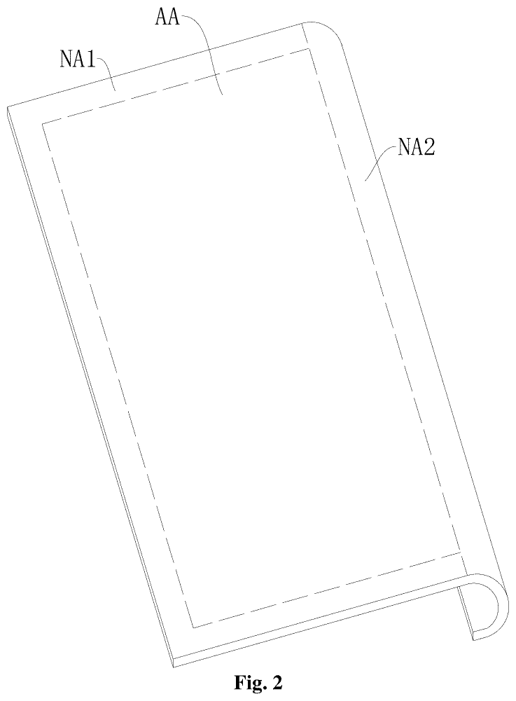

Please refer to FIG. 2. FIG. 2 is a schematic structural diagram of a display panel provided by another embodiment of the first aspect of the present application.

According to the display panel provided by the embodiments of the present application, at least a part of the bonding region NA2 is bent to a non-display side of the display panel. The area ratio of the display region AA on a display side of the display panel can be increased, thereby increasing the screen-to-body ratio of the display panel.

In other embodiments, there may be multiple unbonding regions NA1, and the multiple unbonding regions NA1 and the bonding region NA2 surround the circumferential side of the display region AA.

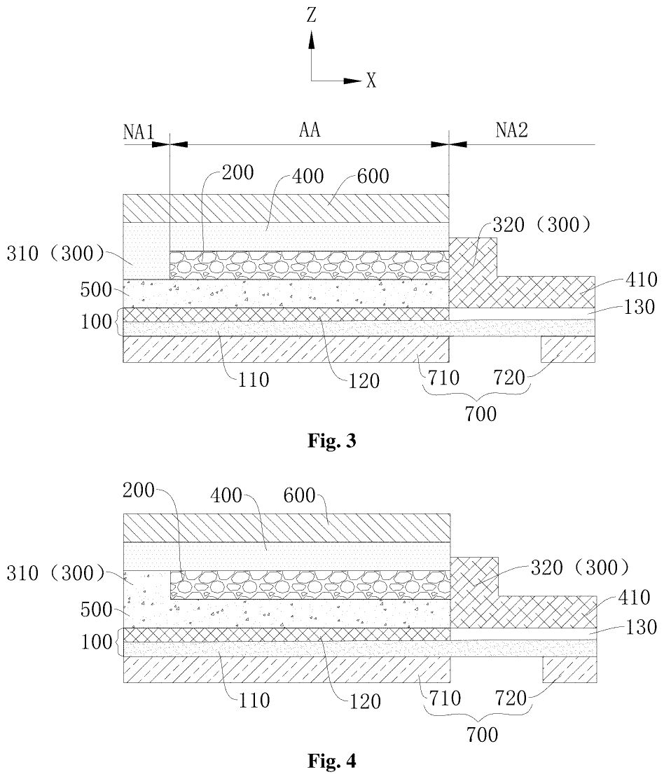

Please refer to FIGS. 1 to 3 together. FIG. 3 is a cross-sectional view of an example of the display panel shown in FIG. 1 along A-A.

According to the display panel provided by the embodiments in the first aspect of the present application, the display panel includes: a display substrate 100 including a substrate 110 and a display device layer 120 disposed on the substrate 110, wherein the display device layer 120 is at least partially located in the display region AA; a polarizer 200 disposed on a side of the display device layer 120 away from the substrate 110, wherein the polarizer 200 includes a first surface away from the substrate 110, a second surface close to the substrate 110, and a side surface connecting the first surface and the second surface; a protection layer including a side protection portion 300 covering at least the side surface.

The display device layer 120 being at least partially located in the display region AA means that at least a part of the display device layer 120 is located in the display region AA. For example, the entire display device layer 120 is located in the display region AA, or a part of the display device layer 120 is located in the display region AA.

The side protection portion 300 covering the side surface means that the side protection portion 300 is in contact with the side surface, which reduces or even avoids the direct contact between the side surface and the external environment. The contact here can be direct contact or indirect contact; the covering means that as long as the orthographic projection of the side surface on the side protection portion 300 is completely covered by the side protection portion 300, the definition of covering in the present application can be satisfied.

In the display panel of the embodiments of the present application, the display panel includes the display substrate 100, the polarizer 200 and the protection layer. The display substrate 100 includes the substrate 110 and the display device layer 120 disposed on the substrate 110, and the display can be realized through the display device layer 120. The side protection portion 300 can at least provide protection to the side surface of the polarizer 200. The side protection portion 300 can better cover the polarizer 200, reduce the contact area between the polarizer 200 and the external environment, and improve the failure of the polarizer 200 caused by water and oxygen invasion. Therefore, in the display panel provided in the embodiments of the present application, the failure of the polarizer 200 can be improved by the side protection portion 300, thereby improving the yield of the display panel.

In the display panel provided by the embodiments of the present application, the substrate 110 may be made of light-transmitting materials such as glass and polyimide (PI). When the bonding region NA2 of the display panel is required to be bent to its backside, the substrate 110 can be made of flexible materials such as polyimide (PI).

The non-display region NA includes a bonding region NA2 and an unbonding region NA1, for example, the portion of the non-display region NA except the bonding region NA2 is the unbonding region NA1.

For example, the display substrate 100 further includes a metal wiring layer 130 disposed on the substrate 110, and the metal wiring layer 130 is located in the bonding region NA2.

There are many ways to arrange the side protection portion 300. For example, the side protection portion 300 includes a first sub-portion 310 located in the unbonding region and a second sub-portion 320 located in the bonding region NA2, wherein the second sub-portion 320 covers at least a part of a surface of the metal wiring layer 130 away from the substrate 110.

In these optional embodiments, the second sub-portion 320 can provide protection to the metal wiring layer 130 and improve the failure of the metal wiring layer 130.

In some optional embodiments, the protection layer further includes a third protection portion 410. For example, the third protection portion 410 is located on a side of the second sub-portion 320 away from the polarizer 200 and covers at least a part of the metal wiring layer 130. The third protection portion 410 can provide better protection to the metal wiring layer 130, which reduces the bending stress on the metal wiring layer 130, and improves the service life of the metal wiring layer 130.

There are many ways to arrange the material of the third protection portion 410, and for example, the third protection portion 410 is an organic film layer. The organic film layer has good flexibility and can meet insulation requirements. The third protection portion 410 has good flexibility and can improve the flexibility of the bonding region NA2 of the display panel, thereby preventing the bonding region NA2 of the display panel from breaking when it is bent. Optionally, the material of the third protection portion 410 includes polyimide, for example.

There are many ways to set the sizes of the first sub-portion 310 and the second sub-portion 320. Optionally, in the non-display region, the minimum distance between the surface of the first sub-portion 310 away from the display region AA and the side surface is 0.1 mm˜0.2 mm. For example, the extension size of the first sub-portion 310 along the X direction in FIG. 3 is 0.1 mm˜0.2 mm. That is, the minimum distance between the polarizer 200 and the surface of the first sub-portion 310 away from the display region AA is 0.1 mm˜0.2 mm.

In these optional embodiments, when the minimum distance between the surface of the first sub-portion 310 away from the display region AA and the side surface is within the above range, it is possible to avoid the breakage and deformation of the first sub-portion 310 caused by the insufficient size of the first sub-portion 310, which otherwise may produce an opening, and the yield of the polarizer 200 may be reduced due to the interaction of the water and oxygen with the polarizer 200 through the opening. Further, it is also possible to avoid the excessive size of the non-display region NA caused by the excessive size of the first sub-portion 310, which otherwise may affect the display effect of the display panel.

Optionally, the minimum distance between the surface of the second sub-portion 320 away from the display region AA and the side surface is 0.1 mm˜0.2 mm, for example, the extension size of the second sub-portion 320 along the X direction in FIG. 3 is 0.1 mm˜0.2 mm.

There are many ways to arrange the protection layer. Optionally, the protection layer further includes a first protection portion 400. The first protection portion 400 is disposed on a side of the polarizer 200 away from the display device layer 120. The first protection portion 400 is connected to the first sub-portion 310.

In these optional embodiments, the first protection portion 400 can provide protection to the first surface of the polarizer 200. The first protection portion 400 is connected to the first sub-portion 310, so that the first protection portion 400 and the first sub-portion 310 can better cover the polarizer 200, which reduces the contact area between the polarizer 200 and the external environment, and improves the failure of the polarizer 200 caused by water and oxygen invasion.

Optionally, the display panel further includes a cover plate 600 located on a side of the first protection portion 400 away from the polarizer 200. The cover plate 600 can provide protection to the layer structure such as the first protection portion 400, the polarizer 200, and the display substrate 100.

There are many ways to arrange the material of the first protection portion 400. For example, the first protection portion 400 is an optical glue layer, and the first protection portion 400 has adhesiveness, so that the polarizer 200 can be bonded to the cover plate 600 through the first protection portion 400.

Optionally, the thickness of the first protection portion 400 is 0.12 mm˜0.18 mm; for example, the thickness of the first protection portion 400 is 0.15 mm.

Optionally, the display panel further includes a support film 700, and the support film 700 includes a first support portion 710 and a second support portion 720. The first support portion 710 is located in the display region AA and provides support on a side of the substrate 110 away from the display device layer 120. The second support portion 720 and the first support portion 710 are spaced apart, the second support portion 720 is located in the bonding region NA2, and the second support portion 720 provides support on a side of the substrate 110 away from the metal wiring layer 130. For example, the second support portion 720 is disposed close to a side of the substrate 110 away from the display region AA. The first support portion 720 may also extend to the unbonding region NA1.

In these optional embodiments, the first support portion 710 and the second support portion 720 are spaced apart, and the portion of the display panel located in the gap between the first support portion 710 and the second support portion 720 has good flexibility, which is convenient for the bent of the display panel.

In some optional embodiments, the display panel further includes a second protection portion 500 disposed on a side of the polarizer 200 toward the display device layer 120, and the second protection portion 500 is connected to the first sub-portion 310. In some optional embodiments, the second protection portion 500 is disposed between the display device layer 120 and the polarizer 200. In some optional embodiments, the second protection portion 500 is in direct contact with the second surface of the polarizer 200.

In these optional embodiments, the second protection portion 500 can provide protection to the surface of the polarizer 200 toward the display device layer 120. The polarizer 200 can be better covered through the first protection portion 400, the first sub-portion 310, the second sub-portion 320 and the second protection portion 500. That is, the surface of the polarizer 200 is in direct contact with the first protection portion 400, the first sub-portion 310, the second sub-portion 320 and the second protection portion 500, which can reduce the contact area between the polarizer 200 and the external environment. Therefore, the failure of the polarizer 200 caused by water and oxygen invasion can be improved, and the yield of the display panel can be improved.

The second protection portion 500 is, for example, an optical glue layer, so that the polarizer 200 can be bonded to the display substrate 100 through the second protection portion 500.

Alternatively, the second protection portion 500 may be an organic film layer, the side protection portion 300 is a glue layer, and the side protection portion 300 is bonded to the second protection portion 500.

Alternatively, both the second protection portion 500 and the side protection portion 300 are glue layers, which can improve the stability of the relative position between the second protection portion 500 and the side protection portion 300.

Optionally, the first sub-portion 310 and the first protection portion 400 are integrated. The first sub-portion 310 and the first protection portion 400 can be formed by deforming and bending the same material layer, which can simplify the fabricating process of the display panel.

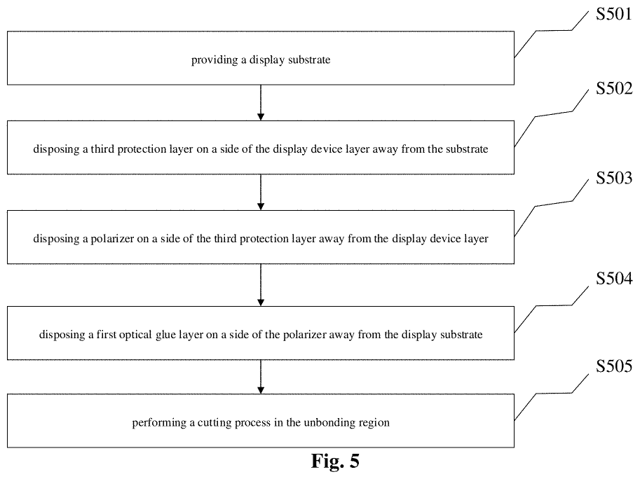

Please refer to FIG. 4. FIG. 4 is a cross-sectional view of another example of the display panel shown in FIG. 1 along A-A.

As shown in FIG. 4, as an example, the first sub-portion 310 and the second protection portion 500 can be integrally formed, and the first sub-portion 310 and the second protection portion 500 can be formed by deforming and bending the same material layer, which simplifies the fabricating process of the display panel.

In some other embodiments, a part of the first sub-portion 310 is integrated with the first protection portion 400, and another part of the first sub-portion 310 is integrated with the second protection portion 500.

Optionally, the thickness of the second sub-portion 320 is greater than or equal to the sum of the thicknesses of the second protection portion 500 and the polarizer 200. The thickness of the second sub-portion 320 is relatively thick, and the second sub-portion 320 can cover more portions of the side surface. That is, more portions of the side surface are in direct contact with the second sub-portion 320, which can reduce the contact area between the upper portion of the side surface of the polarizer 200 and the external environment. Therefore, the failure of the polarizer 200 caused by water and oxygen invasion can be improved, and the yield of the display panel can be improved.

There are many ways to arrange the relative positions of the first sub-portion 310 and the second sub-portion 320. For example, the first sub-portion 310 and the second sub-portion 320 are spaced apart around the circumferential side of the polarizer 200.

In other optional embodiments, the first sub-portion 310 and the second sub-portion 320 are connected to each other on the circumferential side of the polarizer 200, and the first sub-portion 310 and the second sub-portion 320 are arranged around the circumferential side of the polarizer 200.

In these optional embodiments, the side surface at different positions around the circumferential side of the polarizer 200 can be covered by the first sub-portion 310 and the second sub-portion 320, which reduces the contact area between the upper portion of the side surface of the polarizer 200 and the external environment. Therefore, the failure of the polarizer 200 caused by water and oxygen invasion can be improved, and the yield of the display panel can be improved.

In some optional embodiments, there are many ways to set the extension size of the first sub-portion 310 in the circumferential direction of the polarizer 200. Optionally, the minimum distance between the outer surface of the first sub-portion 310 and the side surface is 0.1 mm˜0.2 mm.

Optionally, the side surface includes a first circumferential side surface and a second circumferential side surface connected to each other, the second circumferential side surface is located on the side of the polarizer 200 toward the bonding region NA2, and the first circumferential side surface is the surface of the polarizer 200 toward the unbonding region NA1. The minimum distance between the first circumferential side surface and the side surface of the second protection portion 500 away from the display region AA is 0.1 mm˜0.2 mm. For example, the minimum distance between the first circumferential side surface and the side surface of the second protection portion 500 away from the display region AA is 0.1 mm˜0.2 mm.

In these optional embodiments, the minimum distance between the first circumferential side surface and the side surface of the second protection portion 500 away from the display region AA is 0.1 mm˜0.2 mm. For example, in the X direction, the side surface of the second protection portion 500 away from the display region AA protrudes over the side surface of the polarizer 200 away from the display region AA. Therefore, the first sub-portion 310 can be connected to a portion of the second protection portion 500 protruding over the polarizer 200, and the second protection portion 500 leaves connection space for the first sub-portion 310.

In these optional embodiments, the minimum distance between the first circumferential side surface and the side surface of the first protection portion 400 away from the display region AA is 0.1 mm˜0.2 mm. For example, in the X direction, the side surface of the first protection portion 400 away from the display region AA protrudes over the side surface of the polarizer 200 away from the display region AA. Therefore, the first sub-portion 310 can be connected to a portion of the first protection portion 400 protruding over the polarizer 200, and the first protection portion 400 leaves connection space for the first sub-portion 310.

In these optional embodiments, for example, in the X direction, the side surface of the first protection portion 400 away from the display region AA protrudes over the side surface of the polarizer 200 away from the display region AA. The side surface of the second protection portion 500 away from the display region AA protrudes over the side surface of the polarizer 200 away from the display region AA. Therefore, the first sub-portion 310 can be connected to portions of the first protection portion 400 and the second protection portion 500 protruding over the polarizer

Optionally, on a side of the bonding region NA2, the second circumferential side surface and the side of the second protection portion 500 close to the bonding region NA2 are aligned. That is, the second circumferential side surface and the side of the second protection portion 500 close to the bonding region NA2 are aligned in the thickness direction. The “aligned” here is not a strict aligned in a mathematical sense, as long as the distance between the second circumferential side surface and the edge of the second protection portion 500 is within an error range. For example, the distance between the second circumferential side surface and the side of the second protection portion 500 close to the bonding region NA2 is less than or equal to 0.08 mm.

Under a condition that the second circumferential side surface and the side of the second protection portion 500 close to the bonding region NA2 are not aligned, for example, under a condition that in the X direction, the distance between the second circumferential side surface and the bonding region NA2 is less than the distance between the side of the second protection portion 500 close to the bonding region NA2 and the bonding region NA2, a part of the protruding surface of the polarizer 200 is not covered by the second protection portion 500, and there will be a gap between the polarizer 200 and the display substrate 100. Due to process reasons, it is difficult for the second sub-portion 320 to fill into the gap, so that there is a gap between the polarizer 200, the second sub-portion 320 and the second protection portion 500, which affects the yield of the polarizer 200. Alternatively, under a condition that in the X direction, the distance between the second circumferential side surface and the bonding region NA2 is greater than the distance between the side of the second protection portion 500 close to the bonding region NA2 and the bonding region NA2, the second protection portion 500 may damage the metal wiring layer 130 in the bonding region NA2.

In the display panel provided by the embodiments of the present application, the second circumferential side surface and the edge of the second protection portion 500 are aligned, which can not only avoid affecting the yield of the polarizer 200, but also improve the damage of the second protection portion 500 to the metal wiring layer 130. The edge of the second protection portion 500 is the side of the second protection portion 500 close to the bonding region NA2.

Optionally, the second circumferential side surface and the edge of the first protection portion 400 are aligned. That is, the second circumferential side surface and the edge of the first protection portion 400 are aligned in the thickness direction. The “aligned” here is not a strict aligned in a mathematical sense, as long as the distance between the second circumferential side surface and the edge of the first protection portion 400 is within an error range. For example, the distance between the second circumferential side surface and the edge of the first protection portion 400 is less than or equal to 0.08 mm. The edge of the first protection portion 400 is the side of the first protection portion 400 close to the bonding region NA2.

Optionally, the second circumferential side surface and the side of the first protection portion 400 toward the bonding region NA2 are connected to the second sub-portion 320.

Under a condition that the second circumferential side surface and the edge of the first protection portion 400 are not aligned, for example, under a condition that the edge of the first protection portion 400 protrudes over the second circumferential side surface, there will be a gap between the first protection portion 400 and the metal wiring layer 130. It is difficult for the second sub-portion 320 to fill into the gap, thereby resulting in a void formed between the polarizer 200, the first protection portion 400 and the second sub-portion 320. Under a condition that the second circumferential side surface protrudes over the polarizer 200, a part of the surface of the polarizer 200 toward the cover plate 600 is not covered by the first protection portion 400.

In the display panel provided by the embodiments of the present application, the second circumferential side surface and the edge of the first protection portion 400 are aligned. Therefore, a part of the polarizer 200 being not covered by the first protection portion 400 caused by the second circumferential side surface protruding over the edge of the first protection portion 400 can be avoided. Further, gaps formed between the first protection portion 310, the second sub-portion 320 and the polarizer 200 can also be avoided.

There are many ways to set the thickness of the second protection portion 500, for example, the thickness of the second protection portion 500 is 0.02˜0.08 mm. For example, the thickness of the second protection portion 500 is 0.05 mm.

Optionally, the display device layer 120 includes a driving circuit layer and a light-emitting structure layer, the driving circuit layer is disposed on the substrate 110, and the light-emitting structure layer is located on a side of the driving circuit layer away from the substrate 110.

The driving circuit layer includes, for example, thin film transistors, driving capacitors, data lines, scanning lines and the like. The side of the driving circuit layer away from the substrate 110 is further provided with film layer structures such as a planarization layer, a pixel electrode layer, a pixel definition layer, a light-emitting structure layer, a common electrode layer, and an encapsulation layer.

There are many ways to arrange the metal wiring layer 130. The metal wiring layer 130 is a circuit for connecting an external IC, for example, the metal wiring layer 130 is a COF circuit.

The embodiments of a second aspect of the present application further provide a display apparatus, including the above display panel. Since the display apparatus provided by the embodiments of the present application includes the above display panel, the display apparatus provided by the embodiments of the present application has the beneficial effects of the above display panel, which will not be repeated here.

The display apparatus provided by the embodiments of the second aspect of the present application includes, but is not limited to, mobile phones, personal digital assistants (PDAs), tablet computers, e-books, televisions, door controllers, smart fixed phones, consoles, and other devices having display functions.

Please also refer to FIG. 5. FIG. 5 is a flowchart of a fabrication method of a display panel provided by an embodiment of a third aspect of the present application. The display panel may be the display panel in any embodiment of the above first aspect.

According to the fabrication method of the display panel provided by the embodiment of the third aspect of the present application, the fabrication method of the display panel includes steps S501-S505.

Step S501: providing a display substrate 100.

The display substrate 100 includes a substrate 110 as well as a display device layer 120 and a metal wiring layer 130 disposed on the substrate 110 and interconnected with each other, wherein the display device layer 120 is located in the display region AA, and the metal wiring layer 130 is located in the bonding region NA2. The display device layer 120 includes, for example, a driving circuit layer and a light-emitting structure layer located on a side of the driving circuit layer away from the substrate 110.

Step S502: disposing a third protection layer on a side of the display device layer 120 away from the substrate 110.

Step S503: disposing a polarizer 200 on a side of the third protection layer away from the display device layer 120.

The polarizer 200 includes a first surface, a second surface, and a side surface connecting the first surface and the second surface. For example, the first surface is located on a side of the polarizer 200 toward the display substrate 100, and the second surface is located on a side of the polarizer 200 away from the display substrate 100.

Step S504: disposing a first optical glue layer on a side of the polarizer 200 away from the display substrate 100.

The first optical glue layer includes a first protection layer.

Step S505: performing a cutting process in the unbonding region NA1.

The cutting process is performed in the unbonding region NA1, so that a first protection portion 400, a second protection portion 500 and a first sub-portion 310 are formed by the first protection layer and the third protection layer. The first protection portion 400 is located on a side of the polarizer 200 away from the display device layer 120, the first sub-portion 310 contacts a part of the side surface, and the second protection portion 500 is located on a side of the polarizer 200 toward the display device layer 120.

For example, a laser can be used to perform the cutting process. At this time, under the irradiation of the laser, the first protection layer will be deformed to form the first protection portion 400 and the first sub-portion 310.

In the display panel fabricated according to the fabrication method provided by the embodiments of the present application, the first protection portion 400 can provide protection to the surface of the polarizer 200 away from the display device layer 120, and the first sub-portion 310 can provide protection to a part of the side surface of the polarizer 200. The second protection portion 500 can cover the second surface, which further reduces the contact area between the polarizer 200 and the external environment, and improves the failure of the polarizer 200 caused by water and oxygen invasion. Therefore, in the display panel of the embodiments of the present application, the failure of the metal wiring layer 130 and the polarizer 200 can be improved through the first protection portion 400, the first sub-portion 310 and the second protection portion 500, thereby improving the yield of the display panel.

Optionally, the side surface includes a first circumferential side surface toward the unbonding region NA1 and a second circumferential side surface toward the bonding region NA2, and the second circumferential side surface is located on the side of the polarizer 200 toward the bonding region NA2. In the first circumferential side surface, the first protection portion 400 and the second protection portion 500 are connected to each other through the first sub-portion 310. The first protection portion 400, the second protection portion 500 and the first sub-portion 310 can better cover the polarizer 200, which reduces the contact area between the polarizer 200 and the external environment.

Optionally, in the unbonding region NA1, in the step of disposing the polarizer 200 on the side of the second protection portion 500 away from the display device layer 120, the second protection portion 500 protrudes over the first circumferential side surface. Further, the distance between the first circumferential side surface and the side surface of the second protection portion 500 away from the display region AA is 0.1 mm˜0.2 mm.

In these embodiments, the second protection portion 500 protrudes over the first circumferential side surface, so that the second protection portion 500 can cover the entire second surface, thereby reducing the contact area between the polarizer 200 and the external environment. In addition, the distance between the edge of the second protection portion 500 and the first circumferential side surface is 0.1 mm˜0.2 mm, which can leave enough space for the connection of the first sub-portion 320 and the second protection portion 500.

Optionally, in the unbonding region NA1, the first optical glue layer protrudes over the polarizer 200, and the distance between the first circumferential side surface and the side of the first optical glue layer away from the display region AA is 0.1 mm˜0.2 mm. That is, the distance between the first circumferential side surface and the outer surface of the first protection layer 300 away from the display region AA is 0.1 mm˜0.2 mm, which can leave enough space for the formation of the first sub-portion 310. The first protection layer 300 within the interval of 0.1 mm˜0.2 mm can form the first sub-portion 310.

Optionally, in the step of performing a cutting process in the unbonding region NA1, the distance between the cutting position and the first circumferential side surface is 0.1 mm˜0.2 mm. It can not only prevent the laser cutting from damaging the polarizer 200, but also ensure that there is enough first protection layer 300 to form the first sub-portion 310.

Optionally, before step S504, the fabrication method further includes: disposing a second protection layer in the bonding region NA2 and on a side of the metal wiring layer 130 away from the substrate 110, wherein the second protection layer contacts a part of the side surface; and performing a curing process on the second protection layer to form a panel to be cut. The second protection layer provides protection to the metal wiring layer 130, and improves the failure of the metal wiring layer 130 caused by bending.

Optionally, before performing the curing process on the second protection layer, the first protection layer is protected, wherein the first optical glue layer includes a first duplex film layer located on a side of the first protection layer away from the polarizer 200 and an anti-ultraviolet protection film layer located on a side of the first duplex film layer away from the first protection layer, wherein the anti-ultraviolet protection film layer is configured to protect the first protection layer while performing the curing process on the second protection layer.

There are many ways to perform the curing process on the second protection layer, for example, perform the curing process on the second protection layer by ultraviolet rays. At this time, since the first optical glue layer is covered by the anti-ultraviolet protection film layer, the curing process on the second protection layer will not affect the first protection layer of the first optical glue layer. The second protection layer can be cured to form the second sub-portion 320. Optionally, the side surface includes a second circumferential side surface toward the bonding region NA2, and the second circumferential side surface is covered by the second sub-portion 320 to realize side protection of the second circumferential side surface. In addition, the first protection portion 400 and the side surface of the second protection portion 500 toward the bonding region are also connected to each other through the second sub-portion 320. Therefore, the first protection portion 400, the second protection portion 500 and the second sub-portion 320 can better cover the polarizer 200, which reduces the contact area between the polarizer 200 and the external environment.

After the second protection layer is cured, no ultraviolet rays affect the first protection layer 300. Therefore, the anti-ultraviolet film can be removed after the second protection layer is cured. For example, the anti-ultraviolet protection film layer can be removed before or after performing the cutting process in the unbonding region NA1.

For example, if the anti-ultraviolet film is removed before performing the cutting process in the unbonding region NA1, then the step of performing the cutting process in the unbonding region NA1 can be performed in a similar manner as the prior art, which simplifies the process.

Alternatively, after performing the cutting process in the unbonding region NA1, the first duplex film and the anti-ultraviolet film can be removed together, which can simplify the process steps.

Optionally, after performing the cutting process in the unbonding region NA1, the fabrication method of the display panel further includes: removing the first duplex film layer; disposing a cover plate 600 on the side of the first protection portion 400 away from the polarizer 200; and performing a defoaming and curing process to form the display panel. The cover plate may be a cover plate with curved sides, and the curved cover plate deforms the non-display region of the display substrate, so that the side protection portion of the non-display region of the display substrate can better cover the side surface of the polarizer.

While the present application has been described with reference to preferred embodiments, various modifications may be made and equivalents may be substituted for elements thereof without departing from the scope of the present application. In particular, as long as there is no structural conflict, the technical features mentioned in the various embodiments can be combined in any manner. The present application is not limited to the specific embodiments disclosed herein, but includes all technical solutions falling within the scope of the claims.

What is claimed is:

1. A display panel comprising a display region and a non-display region, wherein the non-display region comprises a bonding region and an unbonding region, and the display panel comprises:
a display substrate comprising a substrate and a display device layer disposed on the substrate, wherein the display device layer is at least partially located in the display region;
a polarizer disposed on a side of the display device layer away from the substrate, wherein the polarizer comprises a first surface away from the substrate, a second surface close to the substrate, and a side surface connecting the first surface and the second surface; and
a protection layer comprising a side protection portion covering at least the side surface.

2. The display panel according to claim 1, wherein the side protection portion comprises a first sub-portion located in the unbonding region and a second sub-portion located in the bonding region, wherein the bonding region is provided with a metal wiring layer located on the substrate, and the second sub-portion covers at least a part of a surface of the metal wiring layer away from the substrate.

3. The display panel according to claim 2, wherein a side of the first sub-portion toward the bonding region is connected to a side of the second sub-portion close to the polarizer.

4. The display panel according to claim 2, wherein the protection layer further comprises a first protection portion disposed on a side of the polarizer away from the display device layer, and the first protection portion is connected to the first sub-portion.

5. The display panel according to claim 4, wherein a surface of the first protection portion toward the bonding region is flush with a surface of the polarizer toward the bonding region.

6. The display panel according to claim 4, wherein a side of the first protection portion toward the bonding region is connected to a side of the second sub-portion close to the polarizer.

7. The display panel according to claim 4, wherein the protection layer further comprises a second protection portion disposed on a side of the polarizer toward the display device layer, and the second protection portion is connected to the first sub-portion.

8. The display panel according to claim 7, wherein the first sub-portion is integrated with the first protection portion, or
the first sub-portion is integrated with the second protection portion, or
a part of the first sub-portion is integrated with the first protection portion, and another part of the first sub-portion is integrated with the second protection portion.

9. The display panel according to claim 7, wherein a surface of the second protection portion toward the bonding region is flush with a surface of the polarizer toward the bonding region.

10. The display panel according to claim 9, wherein the second sub-portion further covers a side surface of the second protection portion, and a thickness of the second sub-portion is greater than or equal to a sum of a thickness of the second protection portion and a thickness of the polarizer.

11. The display panel according to claim 7, wherein
the second protection portion is a glue layer, and the second protection portion is bonded to the side protection portion; and/or
the side protection portion is a glue layer, and the side protection portion is bonded to the second protection portion.

12. The display panel according to claim 2, wherein the protection layer further comprises a third protection portion, the third protection portion is located on a side of the second sub-portion away from the polarizer and covers at least a part of the metal wiring layer.

13. The display panel according to claim 2, further comprising a support film having a first support portion and a second support portion, wherein the first support portion is located in the display region and provides support on a side of the substrate away from the display device layer,
the second support portion and the first support portion are spaced apart, the second support portion is located in the bonding region, and the second support portion provides support on a side of the substrate away from the metal wiring layer.

14. The display panel according to claim 7, wherein a surface of the polarizer is in direct contact with the first protection portion, the first sub-portion, the second sub-portion, and the second protection portion.

15. The display panel according to claim 7, wherein the first sub-portion of the side protection portion is connected to a portion of at least one of the first protection portion and the second protection portion protruding over the polarizer.

16. A display apparatus comprising the display panel according to claim 1.

17. A fabrication method of the display panel according to claim 1, wherein the fabrication method comprises:
providing a display substrate, wherein the display substrate comprises a substrate as well as a display device layer and a metal wiring layer disposed on the substrate and interconnected with each other, wherein the display device layer is located in the display region, and the metal wiring layer is located in the bonding region;
disposing a third protection layer on a side of the display device layer away from the substrate;
disposing a polarizer on a side of the third protection layer away from the display device layer, wherein the polarizer comprises a first surface, a second surface opposite to the first surface, and a side surface connecting the first surface and the second surface;
disposing a first optical glue layer on a side of the polarizer away from the display substrate, wherein the first optical glue layer comprises a first protection layer; and
performing a cutting process in the unbonding region, so that a first protection portion, a second protection portion and a first sub-portion are formed by the first protection layer and the third protection layer, wherein the first protection portion is located on a side of the polarizer away from the display device layer, the first sub-portion contacts a part of the side surface, and the second protection portion is located on a side of the polarizer toward the display device layer.

18. The fabrication method according to claim 17, wherein in the step of performing a cutting process in the unbonding region, so that a first protection portion, a second protection portion and a first sub-portion are formed by the first protection layer and the third protection layer: the first protection layer is deformed to form the first sub-portion and the first protection portion,
the side surface comprises a first circumferential side surface toward the unbonding region and a second circumferential side surface toward the bonding region, and on the first circumferential side surface, the first protection portion is connected to the second protection portion via the first sub-portion.

19. The fabrication method according to claim 17, wherein before performing the cutting process in the unbonding region, the fabrication method further comprises: disposing a second protection layer in the bonding region and on a side of the metal wiring layer away from the substrate, wherein the second protection layer contacts a part of the side surface; and performing a curing process on the second protection layer to form a panel to be cut,
wherein before performing the curing process on the second protection layer, the first protection layer is protected, wherein the first optical glue layer comprises a first duplex film layer located on a side of the first protection layer away from the polarizer and an anti-ultraviolet protection film layer located on a side of the first duplex film layer away from the first protection layer, wherein the anti-ultraviolet protection film layer is configured to protect the first protection layer while performing the curing process on the second protection layer.

20. The fabrication method according to claim 19, wherein before or after performing the cutting process in the unbonding region, the fabrication method further comprises:
removing the anti-ultraviolet protection film layer,
wherein after performing the cutting process in the unbonding region, the fabrication method further comprises:
removing the first duplex film layer;
disposing a cover plate on the side of the first protection layer away from the polarizer; and
performing a defoaming and curing process to form the display panel.
